(19) United States
(12) Patent Application Publication
(10) Pub. No.: US 2007/0296565 A1
(43) Pub. Date: Dec. 27, 2007

(54) Method for Initiating Safety Measures for a Motor Vehicle

(75) Inventor: Timo Himmel, Nufringen (DE)

Correspondence Address: CROWELL & MORING LLP;INTELLECTUAL PROPERTY GROUP, P.O. BOX 14300, WASHINGTON, DC, 20044-4300, US

(73) Assignee: DAIMLERCHRYSLER AG, Stuttgart (DE)

(21) Appl. No.: 11/587,589

(22) PCT Filed: Apr. 21, 2005
(86) PCT No.: PCT/EP05/04291

§ 371 Date: Aug. 2, 2007

(30) Foreign Application Priority Data
Apr. 27, 2004 (DE) 10 2004 020 573.

(51) Int. Cl. B60Q 1/00

(52) U.S. Cl. 340/435

(57) ABSTRACT

The invention relates to a method for initiating safety measures for a motor vehicle in which a transceiver unit of the motor vehicle emits an electromagnetic field into a predefined, close surrounding area of the motor vehicle, if a second motor vehicle is located in the predefined, close surrounding area of the first motor vehicle a transceiver unit of the second motor vehicle transmits a response signal which is received by the transceiver unit of the first motor vehicle. According to the invention it is proposed that safety measures for the first motor vehicle are initiated before the occurrence of the accident event as soon as the response signal is received.

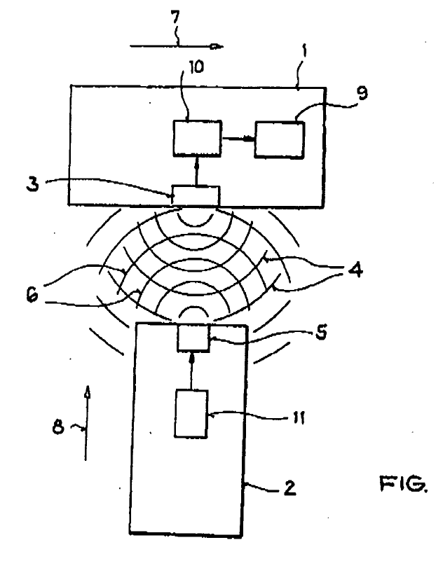

### BACKGROUND AND SUMMARY OF THE INVENTION

This invention relates to a method for initiating safety measures for a motor vehicle, in which a transceiver unit of the motor vehicle emits an electromagnetic field into a predefined, close surrounding area of the motor vehicle.

German document DE 102 33 163 A1 discloses an arrangement for avoiding or attenuating a collision between two motor vehicles. One radar device arranged on a first motor vehicle is provided for sensing a surrounding area, for sensing a second motor vehicle, and for producing information describing the second motor vehicle. A computer determines a probability of a possible collision between the two motor vehicles based on the information about the second motor vehicle which is obtained by the radar device. The computer causes a directional interrogation signal to be emitted in the direction of the second motor vehicle by the radar device if the probability of a collision is sufficiently high. The second motor vehicle has a transponder for receiving the interrogation signal and for transmitting a response signal which contains the dynamic and/or static features of the second motor vehicle. The computer of the first motor vehicle evaluates the response signal and initiates corresponding safety measures for the first motor vehicle in order to prevent or attenuate the effects of a collision.

The invention has the object of specifying a method for initiating safety measures for a motor vehicle in which a transceiver unit of the motor vehicle emits an electromagnetic field into a predefined, close surrounding area of the motor vehicle, which method constitutes a simplified alternative to the methods known from the prior art and permits rapid triggering of the safety measures, in particular in the event of a side impact.

The object mentioned is achieved by a method for initiating safety measures for a motor vehicle as claimed, in which a transceiver unit of the motor vehicle emits an electromagnetic field into a predefined, close surrounding area of the motor vehicle.

According to the invention, the safety measures for the motor vehicle are initiated before the occurrence of the accident event and as soon as the response signal is received. In the method for initiating safety measures for the motor vehicle, the transceiver unit of the motor vehicle emits an electromagnetic field into a predefined, close surrounding area of the motor vehicle. If the first motor vehicle is present in the predefined, close surrounding area of the second motor vehicle, the transceiver unit of the second motor vehicle emits a response signal which is received by the transceiver unit of the first motor vehicle. The method for initiating suitable safety measures for the first motor vehicle is suitable for accident scenarios in which two motor vehicles collide. In order to increase the protection of vehicle occupants, motor vehicles are being provided with more and more devices which trigger in an increasingly differentiated fashion. This relates essentially to the development of airbag systems, the flexible actuation of seatbelt pretensioners, and the use of switchable or modified absorber elements. In order to protect the vehicle occupants of a motor vehicle, and possibly another party to a collision, by such flexible components, knowledge about specific safety-related information relating to the possible other party to a collision is very useful. It is advantageous if such safety-related information comprises an indication of the class of a vehicle, type of a vehicle, mass, unladen weight or maximum permissible overall weight, height, width and/or velocity of the other party to the collision. If the possible other party to the collision has, for example, a large mass, the safety devices or protection devices should be set as hard as possible. If the other party has a relatively small mass, the safety devices or protection devices should react softly in order to permit the occupants of the motor vehicle and of the possible other party to the collision to utilize the deformation path in an optimized fashion. Precise knowledge of the mass and/or of other safety-related variables of the possible other party to the collision is highly important for this. The transceiver unit of the first motor vehicle and the transceiver unit of the second motor vehicle can be integrated on a series production basis or retrofitted as a component of, in each case, a safety device in a motor vehicle, either separately or together.

According to one feature of the invention, the transceiver unit of the first motor vehicle emits the electromagnetic field into a lateral surrounding area of the first motor vehicle and the transceiver unit of the second motor vehicle transmits its response signal in the direction of travel as it approaches the first motor vehicle laterally. The method according to the invention is particularly suitable for a side impact as an accident event since the relative speed between the first and second motor vehicles is generally smaller than in the case of a frontal collision, and the lateral surrounding areas are in practice often not monitored with the same observation means as a front surrounding area of the first motor vehicle.

According to a further feature of the invention, further data relating to the safety of the travel operation is taken into account in order to initiate suitable safety measures before the occurrence of the accident event. The data relevant to the safety of the travel operation can in particular be travel state variables. Travel state variables which can be used are variables such as the velocity of the vehicle, yaw accelerations, longitudinal accelerations and lateral accelerations, positions of the brake pedal and acceleration pedal, and the steering angle. Furthermore, the status of operator control elements such as direction indicator lights and hazard warning lights as well as the status of sensors and control units which relate to the motor vehicle can be used as travel state variables.

Alternatively or in addition, the data relevant to the safety of the travel operation can be data relating to the surroundings. Data relating to the surroundings refers to data which is made available by ambient sensors, telematic systems and by communication between the motor vehicle and other motor vehicles and fixed communications systems. Examples of data relating to the surroundings are information about the current location, about the road category and the lane on which the driver's own motor vehicle is traveling. Further data relating to the surroundings is, inter alia, the state of the road, the temperature, the weather conditions, the light conditions and the distance from motor vehicles traveling ahead, adjacent motor vehicles, following motor vehicles or oncoming motor vehicles and from other road users.

It is advantageous if the data relevant to the safety of the travel operation are evaluated driver activities. Recording the driver activity comprises, for example, detecting eye movements, direction of viewing and also the operator control processes of operator control elements such as, for example, steering wheel, gear selector lever and brake pedal.

Further advantageous refinements of the invention are reflected in dependent claims.

### BRIEF DESCRIPTION OF THE DRAWINGS

The single drawing FIGURE schematically shows an accident scenario with two involved motor vehicles.

### DETAILED DESCRIPTION OF THE INVENTION

The FIGURE illustrates a first motor vehicle 1 and a second motor vehicle 2 in a traffic scenario which leads to a side impact in an accident event. As a result of a method according to the invention, suitable safety measures 9 for the first motor vehicle 1 are initiated before the occurrence of the accident event in which the second motor vehicle 2 approaches the first motor vehicle 1 from the side. The directions of travel of the two motor vehicles 1, 2 are indicated by the arrows 7, 8. However, the method is also suitable for accident scenarios in which the second motor vehicle 2 approaches the first motor vehicle 1 from another direction.

A transceiver unit 3 which is arranged in a lateral region of the first motor vehicle 1 emits an electromagnetic field 4 into a predefined, close lateral surrounding area of the first motor vehicle 1. A transceiver unit 5 which is arranged in a front area of the second motor vehicle 2 is activated, when it is present in the predefined, close surrounding area of the first motor vehicle 1, by the electromagnetic field 4 of the transceiver unit 3 of the first motor vehicle 1 in such a way that the transceiver unit 5 transmits a response signal 6, containing safety-related information, in the direction of travel of the second motor vehicle 2. The response signal 6 containing the safety-related information is received by the transceiver unit 3 of the first motor vehicle 1, the suitable safety measures 9 being initiated as a function of the safety-related information by means of a control unit 10 for the first motor vehicle 1 before the occurrence of the accident event. The safety-related information can comprise an indication of the class of a vehicle, type of a vehicle, mass, unladen weight or maximum permissible overall weight, height, width and/or velocity of the second motor vehicle 2. The response signal 6 containing the safety-related information thus has two functions: it transmits the safety-related information from the second motor vehicle 2 to the first motor vehicle and serves at the same time as a trigger for the initiation of the suitable safety measures 9 for the first motor vehicle 1, as a result of which the severity of the accident and/or the consequences of the accident can be alleviated. In a further simplified refinement of the invention (not illustrated in more detail), it is possible to dispense with transmitting safety-related information by means of the response signal 6. The response signal 6 serves in this refinement only as a trigger for the initiation of the suitable safety measures 9 for the first motor vehicle 1.

It is also possible to arrange a plurality of transceiver units 3 distributed in the lateral area of the first motor vehicle 1. Likewise, a plurality of transceiver units 5 can be arranged distributed in the front area of the second motor vehicle 2. The transceiver units 3 and/or the transceiver units 5 can be installed in other areas of the motor vehicles 1, 2 depending on the configuration of the safety method according to the invention.

The transceiver unit 3 of the first motor vehicle 1 and the transceiver unit 5 of the second motor vehicle 2 can be installed or retrofitted into the motor vehicles 1, 2 on a series production basis either separately or together as a component of a respective safety device.

In order to initiate suitable safety measures 9 before the actual occurrence of the accident event, further data which is relevant to the safety of the travel operation of the first motor vehicle 1, in particular travel state variables, data relating to the surroundings and/or evaluated driver activities, can additionally be taken into account.

The transceiver unit 5 of the second motor vehicle 2 can have various refinements. In one refinement, the transceiver unit 5 of the second motor vehicle 2 comprises a reception coil (not illustrated further) into which the electromagnetic field 4 of the transceiver unit 3 of the first motor vehicle 1 can induce an electric current, and a chip which is fed by the electric current and which transmits the response signal 6 containing the safety-related information. This refinement of the transceiver unit 5, a so-called transponder solution, is particularly easy to implement since there is no need to set up an electrical connection to an on-board electronic system of the vehicle. If the response signal 6 which contains the safety-related information is to cover the velocity of the second motor vehicle 2, the transceiver unit 5 must be connected to a velocity signal transmitter 11 of the second motor vehicle 2. Alternatively, the velocity of the second motor vehicle 2 can also be determined with the aid of the Doppler effect, in which case the electrical connection to the velocity signal transmitter 11 can then be dispensed with.

The method according to the invention for initiating suitable safety measures 9 for the first motor vehicle 1 before the occurrence of an actual accident event in which the second motor vehicle 2 approaches the first motor vehicle 1 ensures reliable and rapid initiation of suitable safety measures 9 with only little expenditure. It can be used for a plurality of accident scenarios and can, if appropriate, provide the first motor vehicle 1 with precise information about the properties and configurations of the other party to the collision.

1-10. (canceled)

11. A safety method for initiating safety measures for a first motor vehicle in which a transceiver unit of the first motor vehicle emits an electromagnetic field into a predefined, close surrounding area of the first motor vehicle comprising:
transmitting a response signal from a transceiver unit of a second motor vehicle, which is received by the transceiver unit of the first motor vehicle, when the second motor vehicle is located in the predefined, close surrounding area of the first motor vehicle, and
initiating safety measures for the first motor vehicle, before an accident event occurs, as soon as the response signal is received.

12. The safety method as claimed in claim 11, wherein the transceiver unit of the first motor vehicle emits an electromagnetic field into a lateral surrounding area, and wherein the transceiver unit of the second motor vehicle emits its response signal in a direction of travel as it approaches the first motor vehicle laterally.

13. The safety method as claimed in claim 11, wherein the response signal contains safety-related information.

14. The safety method as claimed in claim 13, wherein the safety-related information indicates at least one of a class of vehicle, a type of vehicle, a vehicle mass, a vehicle unladen weight, a maximum permissible overall weight, a vehicle height, a vehicle width, and velocity.

15. The safety method as claimed in claim 11, wherein, in order to initiate suitable safety measures before the accident event occurs, further data relevant to safety of a travel operation are taken into account.

16. The safety method as claimed in claim 15, wherein the further data are at least one of driving state variables, data relating to surroundings, and evaluated driver activities.

17. A safety device for a motor vehicle for carrying out the safety method as claimed in claim 11, wherein the transceiver unit of at least one of the first and second motor vehicles is arranged in a lateral area of that motor vehicle, emits an electromagnetic field, and can receive a response signal.

18. The safety device as claimed in claim 17, wherein a plurality of transceiver units are arranged distributed in the lateral area of the at least one of the motor vehicles.

19. A safety device for a motor vehicle for carrying out the safety method as claimed in claim 11, wherein the transceiver unit is arranged in a front area of that motor vehicle, and can be activated by an electromagnetic field in such a way that it emits a response signal.

20. The safety device as claimed in claim 19, wherein a plurality of transceiver units are arranged distributed in the front area of the at least one of the motor vehicles.

21. The safety device as claimed in claim 19, wherein the transceiver unit has a reception coil, into which the electromagnetic field can induce an electric current, and a chip, which is fed by the electric current and emits the response signal.

22. The safety device as claimed in claim 19, wherein the transceiver unit is formed by a transponder.
